(19) United States
(12) Patent Application Publication
(10) Pub. No.: US 2010/0077477 A1
(43) Pub. Date: Mar. 25, 2010

(54) AUTOMATIC MANAGING SYSTEM AND METHOD FOR INTEGRITY REFERENCE MANIFEST

(76) Inventors: Jae Deok LIM, Daejeon (KR); Byeong Cheol CHOI, Daejeon (KR); So Hee PARK, Daejeon (KR); Jeong Nyeo KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/424,771

(22) Filed: Apr. 16, 2009

(30) Foreign Application Priority Data
Sep. 24, 2008 (KR) 10-2008-0093808

(51) Int. Cl. G08B 21/00

(52) U.S. Cl. 726/22

(57) ABSTRACT

The present invention relates to a system for automatically managing integrity reference information and a method of managing the same. The system includes one or more systems, a system management server, and an integrity management server. The systems are connected over a network and communication with each other. Each of the systems has an integrity measurement program to generate integrity information. The system management server has registration information about each of the systems connected over the network and registration information about a program distributed to each of the systems. Further, the system management server controls network access by each of the systems. If integrity reference information matching integrity information provided from a specific system does not exist in pieces of integrity reference information for verifying integrity of each of the systems, the integrity management server determines whether to register the integrity information as integrity reference information of the specific system depending on whether the specific system has been registered with the system management server.

### CROSS-REFERENCE TO RELATED APPLICATION

This application claims the benefit of Korean Application No. 2008-0093808, filed on Sep. 24, 2008 in the Korean Intellectual Property Office, the disclosure of which is incorporated herein by reference.

### BACKGROUND OF THE INVENTION

1. Field of the Invention

The present invention relates to a system for automatically managing integrity reference information and a method of managing the same, and more specifically to a system for automatically managing integrity reference information and a method of managing the same, in which registration and update of integrity reference information are automatically performed.

The present invention was induced from researches performed as part of IT Growth Engine-Centric Technology Development Business of Ministry of Information and Communication and Institute for Information Technology Advancement of Korea [Project No.: 2007-S-016-02, Project Name: Development of low-cost and large-scale global Internet service solution].

2. Description of the Related Art

In recent years, harmful codes or harmful programs, such as lots of intrusion schemes and worm viruses, are increasing due to the vulnerabilities of system operating systems and applications. The harmful codes or harmful program are installed in a user's computer unknowingly and thus infect the computer. Further, they infect other computers of a network to which the infected computer belongs, so damage to them increases. To prevent this, there is a need for integrity management in executing programs in order to provide reliability in the operation of a system as a matter of the system.

An integrity management method was proposed by the industry standard organization, the Trusted Computing Group (TGC). The TCG proposes a method of measuring integrity in a system, a method of verifying that measured integrity information has not been altered, and so on.

In order to verify the integrity using the integrity information as described above, an integrity reference DB in which the integrity information is stored must maintain integrity reference information about all systems managed in organizations connected over a network and all programs operating in the systems, and the integrity reference information must be maintained to always have the latest value.

Meanwhile, in order for the standards proposed by the TCG to be practically available, rapid and automatic management of integrity reference information for integrity verification is indispensable so that the integrity reference information can be maintained to the latest value. In the case in which the volume of systems to be managed is bulky, a change frequently occurs due to update of programs executed in the systems, and so on, if integrity reference information to verify integrity with respect to the change is not managed rapidly and automatically, high cost and load on the integrity management can occur. This may become an obstacle to an integrity management configuration to guarantee reliability of a network.

### SUMMARY OF THE INVENTION

An object of the present invention is to provide a system for automatically managing integrity reference information and a method of managing the same, in which integrity reference information can be managed rapidly and automatically, so that costs and load consumed for integrity management can be reduced and reliability of a network can be guaranteed.

The above object can be accomplished by a system for automatically managing integrity reference information, including one or more systems connected over a network and communication with each other, each of the systems having an integrity measurement program to generate integrity information; a system management server having registration information about each of the systems connected over the network and registration information about a program distributed to each of the systems, the system management server controlling network access by each of the systems; and an integrity management server for, if integrity reference information matching integrity information provided from a specific system does not exist in pieces of integrity reference information for verifying integrity of each of the systems, determining whether to register the integrity information as integrity reference information of the specific system depending on whether the specific system has been registered with the system management server.

The above object can be accomplished by a method of managing integrity information, including a step of storing integrity reference information for verifying integrity of each system connected to a network; a step of receiving integrity information, which has been generated by measuring integrity of a specific system, from the specific system; a step of comparing the integrity information, provided from the specific system, and the integrity reference information; and an information management step of, if, as a result of the comparison, the integrity reference information matching the integrity information does not exist, determining whether to register or update the integrity information as the integrity reference information depending on whether the specific system has been registered with the network.

In accordance with the system for automatically managing integrity reference information and the method of managing the same, in the case in which a system is newly registered with a network or a program is newly installed in a system that has already been registered or updated in the system, integrity reference information is newly registered or updated. Accordingly, since the latest integrity information can be maintained, security reliability of systems constituting a network can be improved.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing the configuration of a system for automatically managing integrity reference information according to the present invention;

FIG. 2 shows the configuration of a packet including integrity information used in the system for automatically managing integrity reference information according to the present invention;

FIG. 3 shows the configuration of an embodiment of the packet shown in FIG. 2;

FIG. 4 shows the configuration of an integrity reference DB in accordance with an embodiment of the present invention;

FIG. 5 shows the configuration of an integrity reference DB in accordance with another embodiment of the present invention;

FIG. 6 is a message sequencing chart showing a process of registering integrity information when a system is initially registered in the system for automatically managing integrity reference information according to the present invention; and

FIG. 7 is a message sequencing chart showing a process of updating integrity information when a program is updated and newly installed in the system for automatically managing integrity reference information according to the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereafter, the present invention will be described in more detail with reference to the accompanying drawings.

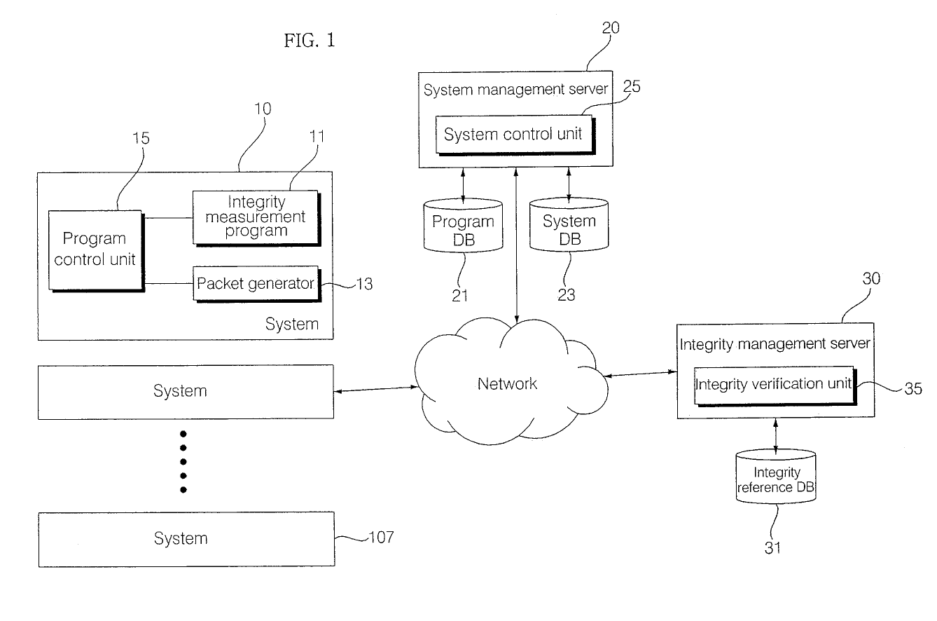

FIG. 1 is a block diagram showing the configuration of a system for automatically managing integrity reference information according to the present invention.

The present system for automatically managing integrity reference information includes a plurality of systems 10 connected over a network, a system management server 20 managing the systems, and an integrity management server 30 managing integrity.

Each of the systems 10 is connected to an internal network or an external network. In the present embodiment, although it is described that the system 10 is a constituent element of the system for automatically managing integrity reference information, a host concept may be used instead of the system 10.

This system 10 includes an integrity measurement program 11, a program control unit 15, and a packet generator 13.

The integrity measurement program 11 measures integrity within the system 10 and operates whenever a preset specific event occurs, at specific time intervals or whenever a request is generated from the integrity management server 30. Here, the specific event can include booting of the system 10, installation of a new program and the like.

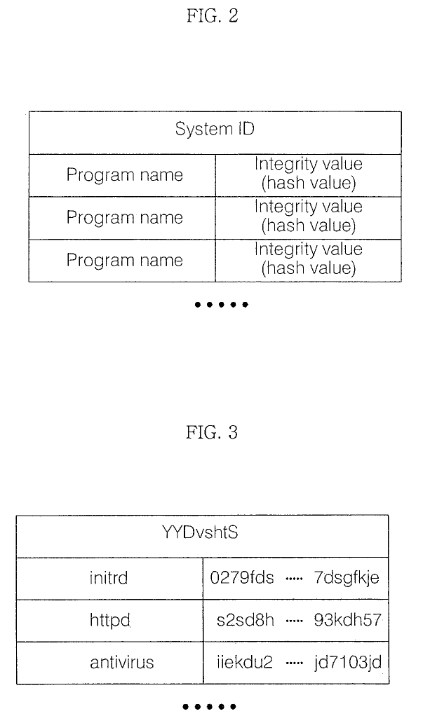

The packet generator 13 generates a packet so that integrity measurement results of the system 10, which are measured in the integrity measurement program 11, can be sent to the integrity management server 30. The format of the packet generated by the packet generator 13 includes, as shown in FIG. 2, a system ID, a program name, and an integrity information value. The system ID is a unique ID assigned to each system 10 and used to identify the system 10 in the integrity management server 30. The program name denotes the name of each program which has been installed at the system 10 and whose integrity has been measured by the integrity measurement program 11. The types and number of installed programs may differ according to the system 10. The integrity information value is represented by a hash value of a corresponding program. FIG. 3 shows an example of a packet.

The program control unit 15 controls the operation of the integrity measurement program 11 and the packet generator 13. The program control unit 15 controls the integrity measurement program 11 to operate whenever a specific event occurs, at specific time intervals or when a request is generated from the integrity management server 30 according to setting. Further, when integrity measurement is completed by the integrity measurement program 11, the program control unit 15 controls the packet generator 13 to generate a packet that is to be sent to the integrity management server 30.

The system management server 20 manages the respective systems 10 connected to the network and programs executed within the respective systems 10. The system management server 20 can store information in a system DB 23 and a program DB 21 or can be provided with information therefrom, and includes a system control unit 25.

The system DB 23 stores information about each system 10 connected to the network. The information about the system 10 includes information about a system ID, a system address, a program installed at the system 10, etc.

The program DB 21 stores programs, which are provided from the system management server 20 to the system 10 and require control and management by the system management server 20 in terms of security. The managed programs can include, for example, OS programs, various patches, vaccine programs, patch/management programs, etc. in the case of an enterprise network, and an Apache server, DB programs, service programs, etc. in the case of a network constructed for specific service, for example, a web service cluster constructed for web service.

The system control unit 25 controls network access by the system 10, such as permission or nonpermission of the network access by the system 10. The system control unit 25 controls access of the system 10 according to integrity information about the system 10, which is provided from the integrity management server 30. For example, in the case in which the system 10 verified by the integrity management server 30 has not been registered with the system DB 23, the system control unit 25 blocks network access by the corresponding system 10. Further, in the case in which a program installed at the system 10 has been distributed or updated by the system management server 20, the system control unit 25 stops the execution of the corresponding program.

The integrity management server 30 verifies the integrity of packets including integrity information, which are provided from the entire systems 10 connected to the network, and manages the integrity information. The integrity management server 30 includes an integrity verification unit 35, and registers and updates integrity reference information stored in an integrity reference DB 31.

The integrity reference DB 31 stores a system ID, the name of a program installed at each system 10, an integrity information value of each program, and integrity reference information including the number of updates. The integrity reference DB 31 can further store information about the last integrity measurement time, version, etc. of a program for the purpose of management convenience and extension.

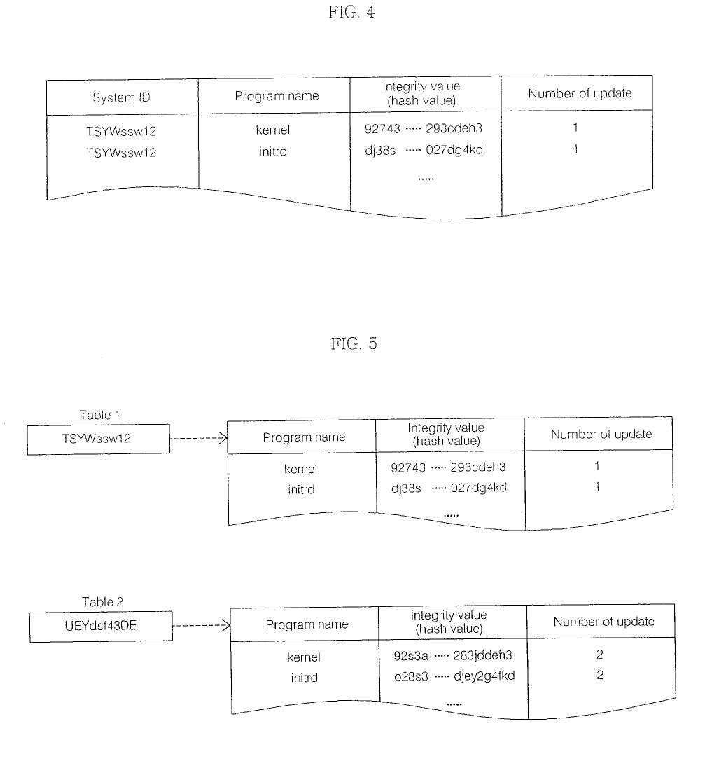

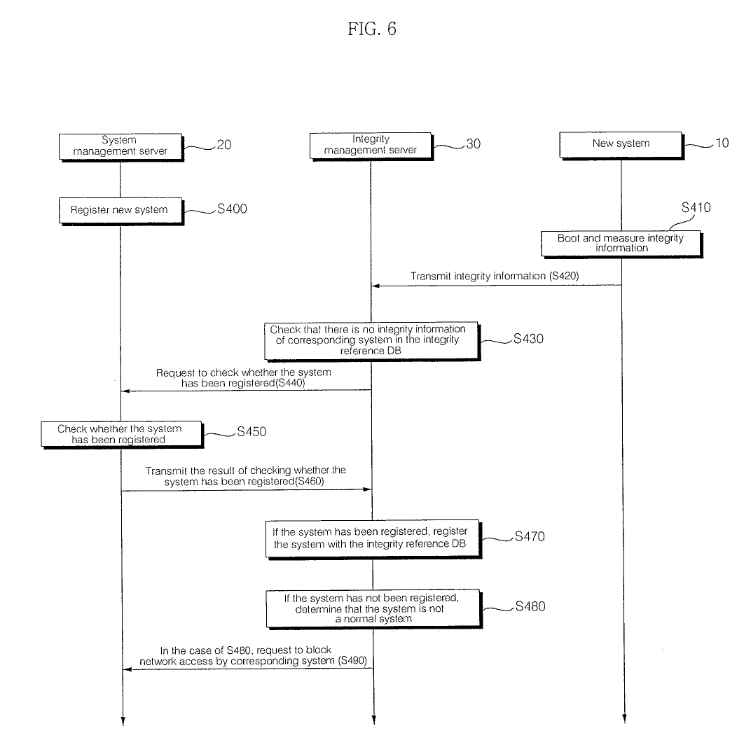

The integrity reference DB 31 may be constructed using one table when the scale of a network is small and may be constructed using a plurality of tables when the scale of a network is large. When the number of the systems 10 connected to a network is not many, the integrity reference DB 31 may be constructed using one table. In this case, as shown in FIG. 4, a system ID, a program name, an integrity information value, and the number of updates are stored in one table. When the number of the systems 10 connected to a network and the number of programs installed at the respective systems 10 are many, the integrity reference DB 31 may be constructed using a plurality of tables as shown in FIG. 5. In this case, an additional table can be constructed in each system 10.

When a packet is received from each system 10, the integrity verification unit 35 draws integrity reference information of the corresponding system 10 from the integrity reference DB 31 and compares the drawn integrity reference information with integrity information included in the packet. If, as a result of the comparison, the integrity reference information of the integrity reference DB 31 is identical to the integrity information included in the packet, the integrity verification unit 35 permits transmission of the packet from the corresponding system 10.

Meanwhile, if, as a result of the comparison, the integrity reference information of the integrity reference DB 31 differs from the integrity information included in the packet or integrity reference information about the corresponding system or program does not exist in the integrity reference DB 31, the integrity verification unit 35 determines whether the corresponding system 10 has been registered with the system management server 20 or the corresponding program has been distributed or updated by the system management server 20.

If, as a result of the determination, the corresponding system 10 has been registered with the system management server 20, the integrity verification unit 35 determines that the corresponding system 10 has been newly registered with the system management server 20, stores the integrity information of the corresponding system 10 in the integrity reference DB 31, and registers the new integrity reference information with the integrity reference DB 31. Further, if, as a result of the determination, the corresponding program has been distributed or updated by the system management server 20, the integrity verification unit 35 determines that the program has been newly installed or updated and then registers the integrity information of the corresponding program with the integrity reference DB 31 or updates the integrity information of the corresponding program in the integrity reference DB 31, as integrity reference information. At the same time, the integrity verification unit 35 permits transmission and reception of the packet by the corresponding system 10 and program.

However, if, as a result of the determination, the corresponding system 10 has not been registered with the system management server 20, the integrity verification unit 35 sends a signal, requesting to block network access by the corresponding system 10, to the system management server 20. Further, if, as a result of the determination, the corresponding program has not been distributed or updated by the system management server 20, the integrity verification unit 35 sends a request for controlling the execution of the corresponding program to the system management server 20.

FIG. 6 is a message sequencing chart showing a process of registering integrity information when a system is initially registered in the system for automatically managing integrity reference information according to the present invention.

When a new system 10 attempts access to a network, the system management server 20 registers the system 10 therewith according to a network policy for configuring each enterprise or system. Information about the system 10 is stored in the system DB 23 (S400).

If service preparation for the registered new system 10 is completed through a boot process, the program control unit 15 of the system 10 controls the integrity measurement program 11 to measure the integrity of each program (S410). After the integrity measurement is completed, the packet generator 13 generates the integrity information as a packet, and the program control unit 15 sends the corresponding packet to the integrity management server 30 (S420).

The integrity verification unit 35 of the integrity management server 30 compares the integrity information, included in the corresponding packet, and integrity information stored in the integrity reference DB 31 and, as a result of the comparison, determines that the integrity reference information of the corresponding system 10 does not exist in the integrity reference DB 31 (S430). Accordingly, the integrity verification unit 35 requests the system management server 20 to check whether the corresponding system 10 has been registered with the system DB 23 (S440). The system management server 20 searches the system DB 23 in order to determine whether the corresponding system 10 has been registered with the system DB 23 (S450) and sends the search result to the integrity management server 30 (S460).

If, as a result of the search, the corresponding system 10 has been registered with the system DB 23, it is meant that the integrity information included in the corresponding packet is the original integrity information provided from the corresponding system 10. Therefore, the integrity information included in the corresponding packet must be registered with the integrity reference DB 31 in order for the integrity information to be used as integrity reference information of the corresponding system 10 (S470). Next, the integrity management server 30 stores a system ID, a program name, and an integrity information value, which are included in the packet, in the integrity reference DB 31 and also registers the number of updates as 1.

Meanwhile, if, as a result of the search, the corresponding system 10 has not been registered with the system DB 23, the integrity management server 30 determines that the corresponding system 10 abnormally accesses a network (S480) and thus requests the system management server 20 to control on the corresponding system 10, for example, block of network access (S490). Accordingly, the system management server 20 blocks the network access of the corresponding system 10.

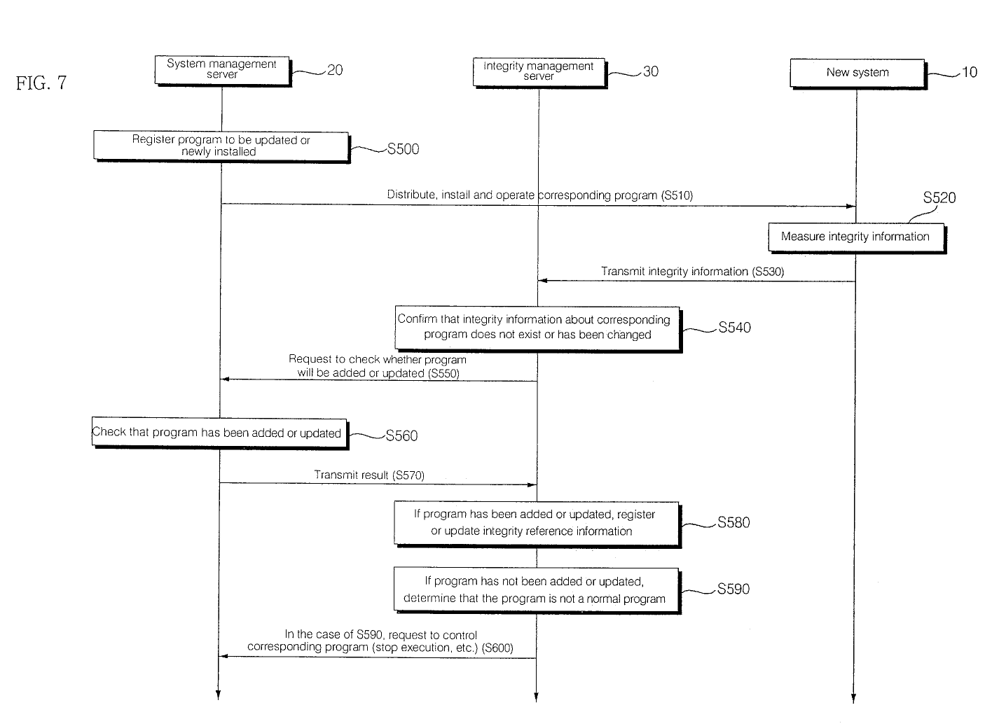

FIG. 7 is a message sequencing chart showing a process of updating integrity information when a program is updated and newly installed in the system for automatically managing integrity reference information according to the present invention.

When it is necessary to newly provide or update a program while the system 10 is normally registered with a network and operated, the system control unit 25 of the system management server 20 registers a program, which will be newly installed or updated, with the program DB 21 (S500) and distributes the corresponding program to the each system 10 of a network (S510). The program control unit 15 of the each system 10 has the distributed program newly installed therein or updated and controls the integrity measurement program 11 to measure the integrity of the program (S520). The measurement result is packetized in the packet generator 13, and the integrity information of the program is then sent to the integrity management server 30 (S530).

The integrity verification unit 35 of the integrity management server 30 compares the integrity information, which is included in the packet and has been received from the corresponding system 10, and integrity reference information stored in the integrity reference DB 31. Since the program has been newly installed or updated, the integrity management server 30 determines that integrity information about the corresponding program does not exist in the integrity reference DB 31 or has been modified (S540). Accordingly, the integrity verification unit 35 requests the system management server 20 to check whether the corresponding program has been newly installed or updated (S550).

The system management server 20 checks information stored in the program DB 21 in order to determine whether the corresponding program has been newly installed or updated (S560) and sends the check result to the integrity management server 30 (S570).

If, as a result of the check, the corresponding program has been newly installed or updated, the integrity verification unit 35 registers the integrity information of the corresponding program with the integrity reference DB 31 as new integrity reference information or changes existing integrity reference information to corresponding integrity information (S580).

Meanwhile, if, as a result of the check by the system management server 20, the corresponding program has not been newly installed or updated, the integrity verification unit 35 determines that the corresponding program has been abnormally installed or altered (S590). Accordingly, the integrity verification unit 35 requests the system management server 20 to control the execution of the corresponding program (S600). In response to the request, the system management server 20 blocks the execution of the corresponding program by the corresponding system 10.

As described above, in accordance with the system for automatically managing integrity reference information 10, in the case in which the system 10 is newly registered with a network, or a program is newly installed in the registered system 10 or updated, the integrity management server 30 checks such a change and newly registers or updates integrity reference information. Accordingly, since integrity information stored in the integrity reference DB 31 can be updated and maintain the latest integrity information, reliability of integrity of each system 10 can be improved.

The present invention is applied to a network and enables integrity reference information to be managed rapidly and automatically. Accordingly, reliability of a network can be guaranteed, and costs and load necessary for integrity management can be reduced.

While the preferred embodiment of the present invention has been shown and described, the present invention is not restricted by the specific embodiment. It is to be appreciated that those skilled in the art can modify the embodiment in various ways without departing from the scope and spirit of the present invention and the modified embodiments should not be construed individually from the technical spirit or prospect of the present invention.

What is claimed is:

1. A system for automatically managing integrity reference information, the system comprising:
one or more systems connected over a network and communication with each other, each of the systems having an integrity measurement program to generate integrity information;
a system management server having registration information about each of the systems connected over the network and registration information about a program distributed to each of the systems, the system management server controlling network access by each of the systems; and
an integrity management server for, if integrity reference information matching integrity information provided from a specific system does not exist in pieces of integrity reference information for verifying integrity of each of the systems, determining whether to register the integrity information as integrity reference information of the specific system depending on whether the specific system has been registered with the system management server.

2. The system of claim 1, wherein the integrity management server comprises:
an integrity reference DB storing the pieces of integrity reference information; and
an integrity verification unit comparing the integrity information provided from each of the systems and the integrity reference information in order to determine integrity of each of the systems.

3. The system of claim 2, wherein if the specific system has been registered with the system management server, the integrity verification unit registers the integrity information with the integrity reference DB as the integrity reference information of the specific system.

4. The system of claim 3, wherein if integrity reference information identical to integrity information about a specific program provided from each of the systems does not exist or differs from the integrity reference information, or the specific program has been distributed or updated by the system management server, the integrity verification unit registers or updates the integrity information of the program as the integrity reference information.

5. The system of claim 2, wherein if the integrity reference information matching integrity information about a specific system or a specific program does not exist and the specific system or the specific program has not been registered with the network, the integrity verification unit requests the system management server to block network access by the specific system or stop execution of the specific program.

6. A method of managing integrity information, the method comprising:
a step of storing integrity reference information for verifying integrity of each system connected to a network;
a step of receiving integrity information, which has been generated by measuring integrity of a specific system, from the specific system;
a step of comparing the integrity information, provided from the specific system, and the integrity reference information; and
an information management step of, if, as a result of the comparison, the integrity reference information matching the integrity information does not exist, determining whether to register or update the integrity information as the integrity reference information depending on whether the specific system has been registered with the network.

7. The method of claim 6, wherein the information management step comprises the step of, if the integrity reference information matching the integrity information provided from the specific system does not exist, but the specific system has been registered with the network, registering the integrity information as integrity reference information of the specific system.

8. The method of claim 6, wherein the information management step comprises the step of, if the integrity reference information matching integrity information of a specific program provided from the each system does not exist, but the specific program has been distributed over the network, registering integrity information about the specific program as the integrity reference information.

9. The method of claim 6, wherein the information management step comprises the step of, if integrity information about a specific program provided from the each system is not identical to the integrity reference information, but the specific program has been updated over the network, updating the integrity information of the specific program as the integrity reference information.

10. The method of claim 6, further comprising the steps of:
if, as a result of the comparison, the specific system has not been registered with the network, blocking network access by the specific system; and
if the integrity reference information matching integrity information of a specific program provided from the each system does not exist and the specific program has not been distributed or updated over the network, stopping execution of the specific program.
